(19) United States
(12) Patent Application Publication
(10) Pub. No.: US 2022/0067954 A1
(43) Pub. Date: Mar. 3, 2022

(54) DYNAMIC MEASUREMENT OPTIMIZATION BASED ON IMAGE QUALITY

(71) Applicant: KONINKLIJKE PHILIPS N.V., EINDHOVEN (NL)

(72) Inventors: Praveen Kumar Pandian Shanmuganathan, Pittsburgh, PA (US); Melody Anne Whittaker, Pittsburgh, PA (US); Kareem Omar, Pittsburgh, PA (US)

(21) Appl. No.: 17/406,546

(22) Filed: Aug. 19, 2021

Related U.S. Application Data
(60) Provisional application No. 63/072,523, filed on Aug. 31, 2020.

(51) Int. Cl. G06T 7/62; G06T 7/00; G06K 9/46; G06K 9/00

(52) U.S. Cl. CPC G06T 7/62; G06T 7/0002; G06K 9/46; G06T 2207/20084; G06T 2207/30168; G06T 2207/30196; G06K 9/00362

(57) ABSTRACT

A method for sizing of an object to be used by a user based upon a user image, including: receiving a user image; determining user features from the user image using a first machine learning model; calculating a set of image quality variables based upon the features from the first machine learning model and user image parameters; determining an accuracy rating based upon the set of image quality variables; determining if the accuracy of the user image is acceptable; determining ruleset adjustments using a second machine learning model when the accuracy of the user image is unacceptable; adjusting a default ruleset based upon the ruleset adjustments; and determining an object size by applying the adjusted ruleset to user features.

### CROSS-REFERENCE TO RELATED APPLICATIONS

This patent application claims the priority benefit under 35 U.S.C. § 119(e) of U.S. Provisional Application No. 63/072,523, filed on Aug. 31, 2020, the contents of which are herein incorporated by reference.

### BACKGROUND OF THE INVENTION

### 1. Field of the Invention

Various exemplary embodiments disclosed herein relate generally to a system and method for dynamic measurement optimization based on image quality.

### 2. Description of the Related Art

In various applications a user might take an image of themselves or some other item, and then that image will be used to determine, for example, size measurements that may be used to determine the size or type of a product to be selected and purchased by the user. Because the quality of the image will vary based upon the camera used and the geometry of the image with respect to the camera, the sizing algorithms may not correctly determine the desired size measurement.

### SUMMARY OF THE INVENTION

A summary of various exemplary embodiments is presented below. Some simplifications and omissions may be made in the following summary, which is intended to highlight and introduce some aspects of the various exemplary embodiments, but not to limit the scope of the invention. Detailed descriptions of an exemplary embodiment adequate to allow those of ordinary skill in the art to make and use the inventive concepts will follow in later sections.

Various embodiments relate to a method for sizing of an object to be used by a user based upon a user image, including: receiving a user image; determining features from the user image using a first machine learning model; calculating a set of image quality variables based upon the features from the first machine learning model and user image parameters; determining an accuracy rating based upon the set of image quality variables; determining if the accuracy of the user image is acceptable; determining ruleset adjustments using a second machine learning model when the accuracy of the user image is unacceptable; adjusting a default ruleset based upon the ruleset adjustments; and determining an object size by applying the adjusted ruleset to user features.

Various embodiments are described, wherein determining user features from the user image includes features from the users face.

Various embodiments are described, wherein determining user features from the user image includes features from one of users foot, users hand, or users joint.

Various embodiments are described, wherein a set of image quality variables includes one of face-to-scene ratios, unconstrained pose, pixel density, aspect ratio, inter-feature distances, and image angle.

Various embodiments are described, further including determining the object size by applying the default ruleset when the user image is acceptable.

Various embodiments are described, further including rejecting the image when the accuracy rating is below an image rejection threshold.

Various embodiments are described, further including rejecting the image when one of the image quality variables is below an associated image variable rejection threshold.

Various embodiments are described, wherein the first machine learning model is a convolutional neural network.

Various embodiments are described, wherein the ruleset adjustments are offset values applied to the default ruleset.

Various embodiments are described, wherein the ruleset adjustments are scale factors applied to the default ruleset.

Further various embodiments relate to a device for sizing of an object to be used by a user based upon a user image, including: a memory; a processor coupled to the memory, wherein the processor is further configured to: determine features from the user image using a first machine learning model; calculate a set of image quality variables based upon the features from the first machine learn model and user image parameters; determine an accuracy rating based upon the set of image quality variables; determine if the accuracy of the user image is acceptable; determine ruleset adjustments using a second machine learning model when the accuracy of the user image is unacceptable; adjust a default ruleset based upon the ruleset adjustments; and determine an object size by applying the adjusted ruleset to user features.

Various embodiments are described, wherein determining user features from the user image includes features from the users face.

Various embodiments are described, wherein determining user features from the user image includes features from one of users foot, users hand, or users joint.

Various embodiments are described, wherein a set of image quality variables includes one of face-to-scene ratios, unconstrained pose, pixel density, aspect ratio, inter-feature distances, and image angle.

Various embodiments are described, wherein the processor is further configured to determine the object size by applying the default ruleset when the user image is acceptable.

Various embodiments are described, wherein the processor is further configured to reject the image when the accuracy rating is below an image rejection threshold.

Various embodiments are described, wherein the processor is further configured to reject the image when one of the image quality variables is below an associated image variable rejection threshold.

Various embodiments are described, wherein the first machine learning model is a convolutional neural network.

Various embodiments are described, wherein the ruleset adjustments are offset values applied to the default ruleset.

Various embodiments are described, wherein the ruleset adjustments are scale factors applied to the default ruleset.

These and other objects, features, and characteristics of the present invention, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention

### BRIEF DESCRIPTION OF THE DRAWINGS

FIG. 1 is an example image showing a low face-to-scene ratio;

FIG. 2 provides an example of an unconstrained pose where the image is of the users side profile;

FIG. 3 illustrates an image in the portrait orientation that has a high aspect ratio;

FIG. 4 illustrates an image taken with a high pose angle;

FIG. 5 illustrates a flow diagram for the image sizing system; and

FIG. 6 illustrates an exemplary hardware device 600 for implementing the image sizing system.

To facilitate understanding, identical reference numerals have been used to designate elements having substantially the same or similar structure and/or substantially the same or similar function.

### DETAILED DESCRIPTION

The description and drawings illustrate the principles of the invention. It will thus be appreciated that those skilled in the art will be able to devise various arrangements that, although not explicitly described or shown herein, embody the principles of the invention and are included within its scope. Furthermore, all examples recited herein are principally intended expressly to be for pedagogical purposes to aid the reader in understanding the principles of the invention and the concepts contributed by the inventor(s) to furthering the art and are to be construed as being without limitation to such specifically recited examples and conditions. Additionally, the term, “or,” as used herein, refers to a non-exclusive or (i.e., and/or), unless otherwise indicated (e.g., “or else” or “or in the alternative”). Also, the various embodiments described herein are not necessarily mutually exclusive, as some embodiments can be combined with one or more other embodiments to form new embodiments.

A mask selector system has been developed that allows a user to take an image of their face and upload it into the system to determine the type and size of a continuous positive airway pressure (CPAP) mask for the user. The mask selector system may be adapted for use with other types of masks as well. The mask selector system analyzes the photograph to identify various features of the users face, for example the width and length of the nose, the size of the mouth, the relative location of the eyes, nose, and mouth, etc. These identified features may then be used to determine a type and size of mask for the user based upon user preferences. This may be done by using a rule set. For example, the nose width and mouth width may be used to determine the mask size and the rules may contain a set of rules based upon these (and other parameters) to determine the users mask size.

In current systems, when using images as input for sizing, the images and the imaging systems are calibrated to work at a specific accuracy guideline. This however limits the users and/or manufacturers to use very specific devices that are tested for a known accuracy. If the accuracy of the imaging system used to take the user image is not known, then the measurements that are extracted from them become unreliable.

The embodiments of an image sizing system described herein provide a way to extract accuracy metrics and then the measurement rules are adjusted accordingly to work effectively for that given accuracy. The measurement rules are then dynamically adjusted to produce a highly accurate output based on the accuracy score.

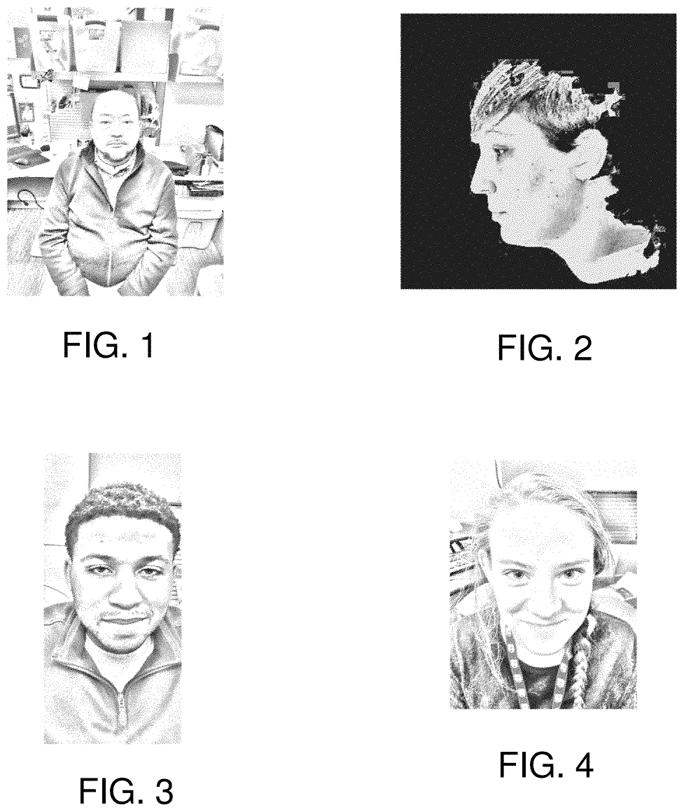

The image quality can effect the ability to correctly determine a user's mask size from the captured image. As the image is taken by a user, the image quality can vary widely. The following are examples of variables that may affect image quality. The face-to-scene ratio is the proportion of face to overall image which may be used to determine the distance between the subject and camera, which allows for better interpretation of measurements extracted from image. FIG. 1 is an example image showing a low face-to-scene ratio. As can be seen the lighting is good and in general the image is good, but the users face is small compared to the rest of the frame. This leads to the measured features on the image being smaller and hence the rules will have to be scaled more to adjust for the small face-to-scene ratio.

Unconstrained poses occur when subjects are pictured in unexpected positions but can still be recognized in the algorithm through comparison to their default positions, allowing for bigger range of image acceptance. The user will be provided instructions regarding posing for the image, but the users will not always conform to those instructions. FIG. 2 provides an example of an unconstrained pose where the image is of the users side profile. In other situations the user may be turned or at other angles. Such situations need to be recognized and the rules adjusted accordingly. Even with a side profile, sufficient measurements may be able to be taken to provide a recommendation to the user.

The image pixel density and thus camera quality may be analyzed to assign an accuracy score, allowing for the system to better interpret the algorithm's results. Because the quality and pixel density of the users camera can vary widely based upon what type of camera is used (for example older laptop computers and phones have lower quality camera's than those found on today's mobile phones for example), variations in pixel density and camera quality will need to be assessed and then the rules adjusted to compensate for quality issues based upon pixel density.

The image aspect ratio may determine whether the image needs to be cropped and/or rotated, ultimately allowing for better interpretation of the extracted image measurements. FIG. 3 illustrates an image in the portrait orientation that has a high aspect ratio. Such an image may need to be cropped to improve the analysis of the image and high aspect ratios can effect the determination of the measurements.

Key landmarks are extracted from the user image and the inter-landmark distances from certain regions of interest may be used as critical features to determine image quality. For example if the inter-landmark distances fall outside normal ranges, then poor image quality may be suspected.

The image angle, determined by the percentage prevalence of the subject's predetermined key features (e.g., percentage of nostril showing may show an image taken from below the user's face), can contribute to an accuracy score. FIG. 4 illustrates an image taken with a high pose angle. Such an angle will skew the measurements of distances in the vertical direction. Accordingly, the rules will need to be adjusted to accommodate for such a pose angle.

Next, the image sizing system will determine an input image accuracy based upon the various variables described above by assigning an accuracy score to the image. The accuracy score allows the image sizing system to qualitatively understand how good or bad an image is. This accuracy score may then be compared to a threshold. If the accuracy is acceptable, the default rules are applied to the measurements to determine the user's size. If the accuracy score is not acceptable, then the default rules may be adjusted based upon the variables described above. The system starts with a default set of rules that then may be dynamically optimized based upon the variables determined above. This allows for input images to have a greater range of variability.

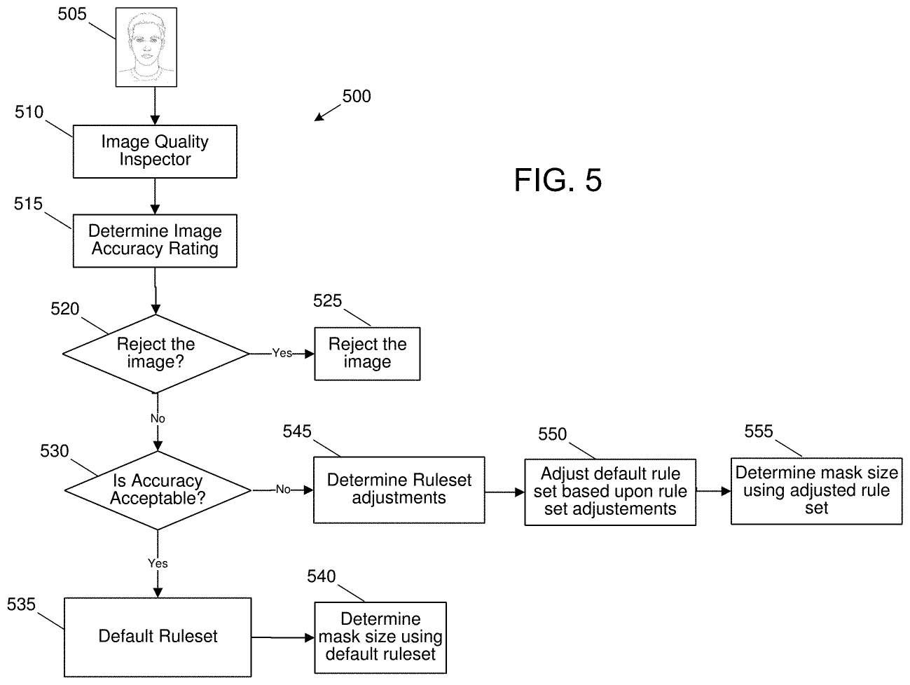

FIG. 5 illustrates a flow diagram for the image sizing system. The image sizing system first receives a user image 505. The image quality inspector 510 receives and analyzes the user image 505. The image quality inspector 510 includes a machine learning model that analyzes the image to produce a three-dimensional (3D) representation of the facial landmarks from the user image 505. For example, the outputs of the machine learning model may be various features including a 3D profile and location of the eyes, the nose, the mouth, the outline of the users jaw, or an outline of the users face. This machine learning model may for example be a convolutional neural network (CNN), but other types of machine learning models may be used as well. The machine learning model may be trained using a training set of images that have been labelled to identify these desired features.

The outputs of the machine learning model may then be further processed to calculate various variables associated with the image. For example, by comparing the vertical position of the two eyes or the vertical position of the ends of the users mouth, a rotation or tilt in the image may be detected. The eyes and the edges of the mouth are expected to be substantially aligned horizontally. Natural variations in these features occur, but if the difference exceeds a threshold value then the users face may be tilted or rotated left or right. These sorts of values may be used to calculate an image angle. Also, when rotations are detected, the image may be rotated to compensate for the detected rotations. This will allow for better interpretation of the extracted image measurements.

Unconstrained poses may also be detected using a pose algorithm on the output of the machine learning model. For example, for a profile view such as shown in FIG. 2, the pose algorithm may determine that there are landmarks for only one eye, which would indicate an unconstrained pose. Also the pose algorithm may recognize that the nose landmarks indicates a view from the side of the nose rather than from the front.

Another algorithm may determine inter-landmark distances, for example, the distance between the eyes as well as other features, to determine if their values are in normal ranges. If not, they may indicate a lack of image quality such as an undesirable image angle.

The face-to-scene ratio may be calculated by using the outline of the users face to calculate the area of the users face. This can then be divided by the total area of the image to arrive at the face-to-scene ratio. A threshold value of 45% may indicate an acceptable face-to-scene ratio.

Also, the aspect ratio of the image may be determined, and if the aspect ratio is to high, then the image may be cropped based upon the location of the users face and features. This may allow for increasing the face-to-scene ratio for the image.

Each of these variables may then be used to determine an image accuracy rating. The image may be rated to produce a score for each of the different variables described above. Each of the variable scores may then be weighted and combined to come up with an image accuracy rating 515. This image accuracy rating provides an indication regarding the accuracy of the image across a number of different variables and considerations.

Next, the image sizing system may determine if the image should be rejected 520. This may be done by comparing the image accuracy rating to a first threshold value. If this value is less than the threshold value the image accuracy is to low, then the image is rejected 525. Also, some or all of the variables that are a part of the image accuracy rating may also be compared to threshold values. If one of these variables exceeds a respective threshold value, then the image quality may also be determined to be unacceptable based upon that one variable, and the image is rejected as well.

Next, the image sizing system determines if the image accuracy is acceptable. This may be done by comparing the image accuracy rating to a second threshold. If the image accuracy is acceptable, then a default rule set 535 is used to determine the mask size. The image sizing system then determines the mask size using the default rule set 540. For example, a small mask may be determined when the nose width is between 4 mm and 10 mm and the mouth width is between 8 mm and 14 mm; a medium mask may be determined when the nose width is between 10.1 mm and 18 mm and the mouth width is between 14.1 mm and 21 mm; and a large mask may be determined when the nose width is between 18.1 mm and 25 mm and the mouth width is between 21.1 mm and 27 mm.

If the accuracy is not acceptable, then the image sizing system may determine ruleset adjustments 545. This may be accomplished using a ruleset adjustment machine learning model using the variables calculated above as inputs. The ruleset adjustment machine learning model may be a regression model, a neural network, or other type of machine learning model. This model may be trained using input images with known variable values and the desired changes to the default ruleset to properly evaluate the image. The output of the ruleset adjustment machine learning model will be set of adjustments to be applied to the various rule parameters. For example, the output may include offsets that indicate that the nose width parameters should be decreased by 2 mm and the mouth width be decreased by 5 mm. In another example, the output may include offsets that indicate that the nose width parameters should be increased by 3 mm and the mouth width be increased by 7 mm. Also, the values of the ruleset may be changes using a scale factor as well, e.g., multiply the nose width values by 1.1 and the mouth width values by 1.05. Various parts of the ruleset may be adjusted based upon the input variables to the ruleset adjustment machine learning model. For example, variations in image angle may lead to a first part of the ruleset being adjusted, while variations in the face-to-scene ratio may lead to a different part of the ruleset being varied.

These outputs are then used to adjust the default rules set 550. The image sizing system then uses the adjusted rule set to determine the mask size 555.

While the system described herein is directed to determining the size of a mask for a user, the image sizing system may be used to measure various parts of the body and to provide sizing for other items. For example, a user's foot could be sized for shoes or the user's hand for gloves. Also the user's face may be sized for eyeglasses. Joints may be measured to determine the sizing for braces. Also the input image may be of an object of a specified type and some other related object is to be sized in relation to the object in the image.

The image sizing system provides a technological advancement over the systems used today. Today's systems determine if the image quality is acceptable. If not then the image is rejected. If so, then a static ruleset is applied to the measurements to determine a mask size. So images with marginal quality will be rejected. The image sizing system will still be able to use such marginal images because various variables regarding the image quality are determined and scored, and this information is used to dynamically adjust the ruleset to compensate for image quality issues and to provide an accurate sizing result. This improvement provides more accurate results and decreases the number of images that are rejected and hence reduces the number of times that a user has to retake pictures.

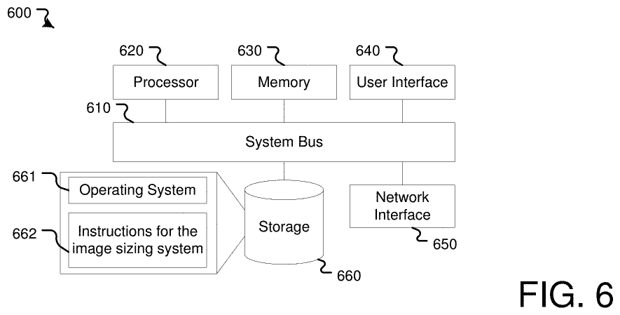

FIG. 6 illustrates an exemplary hardware device 600 for implementing the image sizing system. This device may implement the whole image sizing system, or may also implement various elements of it such as the image quality inspector, the rule adjustment machine learning model, the CNN processing user images, or any other algorithm or model in the image sizing system. As shown, the device 600 includes a processor 620, memory 630, user interface 640, network interface 650, and storage 660 interconnected via one or more system buses 610. It will be understood that FIG. 6 constitutes, in some respects, an abstraction and that the actual organization of the components of the device 600 may be more complex than illustrated.

The processor 620 may be any hardware device capable of executing instructions stored in memory 630 or storage 660 or otherwise processing data. As such, the processor may include a microprocessor, a graphics processing unit (GPU), field programmable gate array (FPGA), application-specific integrated circuit (ASIC), any processor capable of parallel computing, or other similar devices. The processor may also be a special processor that implements machine learning models.

The memory 630 may include various memories such as, for example L1, L2, or L3 cache or system memory. As such, the memory 630 may include static random-access memory (SRAM), dynamic RAM (DRAM), flash memory, read only memory (ROM), or other similar memory devices.

The user interface 640 may include one or more devices for enabling communication with a user and may present information to users. For example, the user interface 640 may include a display, a touch interface, a mouse, and/or a keyboard for receiving user commands. In some embodiments, the user interface 640 may include a command line interface or graphical user interface that may be presented to a remote terminal via the network interface 650.

The network interface 650 may include one or more devices for enabling communication with other hardware devices. For example, the network interface 650 may include a network interface card (NIC) configured to communicate according to the Ethernet protocol or other communications protocols, including wireless protocols. Additionally, the network interface 650 may implement a TCP/IP stack for communication according to the TCP/IP protocols. Various alternative or additional hardware or configurations for the network interface 650 will be apparent.

The storage 660 may include one or more machine-readable storage media such as read-only memory (ROM), random-access memory (RAM), magnetic disk storage media, optical storage media, flash-memory devices, or similar storage media. In various embodiments, the storage 660 may store instructions for execution by the processor 620 or data upon which the processor 620 may operate. For example, the storage 660 may store a base operating system 661 for controlling various basic operations of the hardware 600. The storage 662 may store instructions for implementing the image sizing system and various elements of the image sizing system such as the image quality inspector, the rule adjustment machine learning model, the CNN processing user images, or any other algorithm or model in the image sizing system.

It will be apparent that various information described as stored in the storage 660 may be additionally or alternatively stored in the memory 630. In this respect, the memory 630 may also be considered to constitute a “storage device” and the storage 660 may be considered a “memory.” Various other arrangements will be apparent. Further, the memory 630 and storage 660 may both be considered to be “non-transitory machine-readable media.” As used herein, the term “non-transitory” will be understood to exclude transitory signals but to include all forms of storage, including both volatile and non-volatile memories.

While the system 600 is shown as including one of each described component, the various components may be duplicated in various embodiments. For example, the processor 620 may include multiple microprocessors that are configured to independently execute the methods described herein or are configured to perform steps or subroutines of the methods described herein such that the multiple processors cooperate to achieve the functionality described herein. Such plurality of processors may be of the same or different types. Further, where the device 600 is implemented in a cloud computing system, the various hardware components may belong to separate physical systems. For example, the processor 620 may include a first processor in a first server and a second processor in a second server.

Any combination of specific software running on a processor to implement the embodiments of the invention, constitute a specific dedicated machine.

As used herein, the term “non-transitory machine-readable storage medium” will be understood to exclude a transitory propagation signal but to include all forms of volatile and non-volatile memory.

Although the various exemplary embodiments have been described in detail with particular reference to certain exemplary aspects thereof, it should be understood that the invention is capable of other embodiments and its details are capable of modifications in various obvious respects. As is readily apparent to those skilled in the art, variations and modifications can be affected while remaining within the spirit and scope of the invention. Accordingly, the foregoing disclosure, description, and figures are for illustrative purposes only and do not in any way limit the invention, which is defined only by the claims.

What is claimed is:

1. A method for sizing of an object to be used by a user based upon a user image, comprising:
receiving a user image;
determining features from the user image using a first machine learning model;
calculating a set of image quality variables based upon the features from the first machine learning model and user image parameters;
determining an accuracy rating based upon the set of image quality variables;
determining if the accuracy of the user image is acceptable;
determining ruleset adjustments using a second machine learning model when the accuracy of the user image is unacceptable;
adjusting a default ruleset based upon the ruleset adjustments; and
determining an object size by applying the adjusted ruleset to user features.

2. The method of claim 1, wherein determining user features from the user image includes features from the users face, users foot, users hand, and/or users joint.

3. The method of claim 1, wherein a set of image quality variables includes one of face-to-scene ratios, unconstrained pose, pixel density, aspect ratio, inter-feature distances, and image angle.

4. The method of claim 1, further comprising determining the object size by applying the default ruleset when the user image is acceptable.

5. The method of claim 1, further comprising rejecting the image when the accuracy rating is below an image rejection threshold or rejecting the image when one of the image quality variables is below an associated image variable rejection threshold.

6. The method of claim 1, wherein the first machine learning model is a convolutional neural network.

7. The method of claim 1, wherein the ruleset adjustments are offset values applied to the default ruleset or are scale factors applied to the default ruleset.

8. A device for sizing of an object to be used by a user based upon a user image, comprising:
a memory; and
a processor coupled to the memory, wherein the processor is further configured to:
determine features from the user image using a first machine learning model;
calculate a set of image quality variables based upon the features from the first machine learn model and user image parameters;
determine an accuracy rating based upon the set of image quality variables;
determine if the accuracy of the user image is acceptable;
determine ruleset adjustments using a second machine learning model when the accuracy of the user image is unacceptable;
adjust a default ruleset based upon the ruleset adjustments; and
determine an object size by applying the adjusted ruleset to user features.

9. The device of claim 8, wherein determining user features from the user image includes features from the users face, users foot, users hand, and/or users joint.

10. The device of claim 8, wherein a set of image quality variables includes one of face-to-scene ratios, unconstrained pose, pixel density, aspect ratio, inter-feature distances, and image angle.

11. The device of claim 8, wherein the processor is further configured to determine the object size by applying the default ruleset when the user image is acceptable.

12. The device of claim 8, wherein the processor is further configured to reject the image when the accuracy rating is below an image rejection threshold.

13. The device of claim 8, wherein the processor is further configured to reject the image when one of the image quality variables is below an associated image variable rejection threshold.

14. The device of claim 8, wherein the first machine learning model is a convolutional neural network.

15. The device of claim 8, wherein the ruleset adjustments are offset values applied to the default ruleset or are scale factors applied to the default ruleset.
